(19) United States
(12) Patent Application Publication
(10) Pub. No.: US 2014/0082074 A1
(43) Pub. Date: Mar. 20, 2014

(54) PROCESS, METHOD AND SYSTEM FOR EXCHANGING CONTACT DATA

(71) Applicant: Workman Holdings International, LLC, Chatham, NJ (US)

(72) Inventor: DAVID WORKMAN, Chatham, NJ (US)

(73) Assignee: Workman Holdings International, LLC, Chatham, NJ (US)

(21) Appl. No.: 13/967,902

(22) Filed: Aug. 15, 2013

Related U.S. Application Data
(60) Provisional application No. 61/683,332, filed on Aug. 15, 2012.

(51) Int. Cl. H04L 29/08

(52) U.S. Cl. CPC H04L 67/10
USPC 709/204

(57) ABSTRACT

A method of sharing user data via a global communications network including creating a profile of user data stored on a web server via a software application functioning over the global communications network, accessing the software application with a mobile device, selecting the profile to be shared with another user of the software application, and executing a share function of the software application to share the profile with the another user.

### CROSS REFERENCE TO RELATED APPLICATIONS

The present application claims benefit of U.S. Provisional Application Ser. No. 61/683,332, filed Aug. 15, 2012, the disclosure of which is hereby incorporated by reference herein.

### BACKGROUND OF THE INVENTION

From time to time individuals desire to exchange personal, business, social and other “contact” (and other related) data and information (“Contact Data”). Historically, flow of this information has been achieved through manual exchange of business cards, other written documents, or electronically through manual means.

### SUMMARY OF THE INVENTION

This invention generally relates to a method, process and system for quickly, easily and securely exchanging Contact Data by and between two (2) or more individuals, principally users of the invention. An embodiment of the invention allows such exchange of Contact Data by and between two (2) or more users by using their respective mobile/personal/portable devices (e.g., a smart or cell phone, iPad, pad computers, web-books, etc.) (“Mobile Device”) and accessing and executing a cross-platform software application installed on or otherwise available through each such user's Mobile Device.

The invention incorporates, comprises and includes such Mobile Devices as iPhone, Android, BlackBerry and Windows-based portable/mobile communication devices and those Device's respective and proprietary operating system(s). The type of proprietary Mobile Device, and its respective mobile operating system, are not to be construed as limiting features or limitations on the present invention, as any Mobile Device, including those yet to be marketed, and their respective proprietary operating and communicating systems, may be used to implement the invention, all without departing from the spirit and scope of the invention, as disclosed herein.

In addition to Mobile Devices used by the individual Users of the invention, the invention comprises several integrated portions, as more specifically detailed and described herein.

More specifically, the invention comprises, in part, a cross-platform Mobile Device application or software program portion (“App” or App portion“) installed or otherwise accessible on a user's Mobile Device, that provides for the ready, easy and secured sharing of specific Contact Data with, by and between other chosen users of the invention, by exchanging said Contact Data with each User's Mobile Device through and via other portions of the invention, including, but not limited to, through and via a global communications network (the Internet and related wired and wireless communications networks using the Internet and various data and communications protocols generally known and employed therewith in said communications networks) (collectively, the “Global Network portion”) and further utilizing, in an embodiment, a Global Positioning Satellite system (GPS) portion (the “GPS portion”), an Internet website portion (the “Website” or “Website portion”), various web servers connected to and made a part of the Global Network portion (the “Web Server portion”), various databases and database management programs, applications and platforms (the “Database portion”) installed or stored on or otherwise hosted by the Web Server portion, and other, related and various Internet and data communications hardware, software, and protocols, generally know and relied upon for sending, receiving, transmitting, storing, managing, securing and utilizing data via the Internet and across data communications networks, commonly utilized and generally known to those skilled in the art. FIG. 3 details a sample home page of the Website portion of the invention.

In order to use the invention and exchange Contact Data with other users of the invention, a user (hereinafter, “User” and sometimes referred to as the “first User” or “User 1”) must first download or otherwise acquire the App portion of the invention and install the App portion on, or otherwise make the App portion available through, said User's Mobile Device. The acquisition, by sale or otherwise, of portable device applications is ubiquitous these days and commonly known among both those skilled in the art (for the creation thereof) and those using such applications in conjunction with such mobile devices, e.g., iPhone “Apps” available to users of the iPhone through Apple's “App Store.” Once the App portion of the invention is installed on or otherwise made available through a User's Mobile Device, the User may open or access the App portion and create a secure user account (“User Account”) by and through the App portion. See FIG. 2 showing the App portion installed on a device, which may be opened or accessed by executing the “HiFive Pro” icon, lower left portion of the device display. A User logs onto or otherwise accesses his/her User Account either through the App portion or through the invention's Website portion (portal). Alternatively, a User Account may be created through either means (App portion or Website portion) by a User.

A User Account may be accessed by a User remotely and my include a secure software and/or database account management portion, including the database(s) thereof, and other User-specific Account data and information. A User's User Account data may reside on the Web Server portion, which would comprise at least one remote and secure Internet web server(s) for storing, hosting and maintaining all User Account and other related date, such as, for example, a User's Contacts, Profiles, etc., discussed in greater detail below.

When creating and/or accessing a secure User Account, a User may be required to provide various unique information, data or indicia to identify the User with his or her User Account, (e.g., user name, password, email account, and the like), which shall also provide for the secure management of all data associated with the User's Account, as provided by the User, including User Account data and Contact Data, discussed below (both Contact Data to be exchanged by a first User with one or more second Users of the invention, as created by said first User in one or more User Profile(s) created by that User and Contact Data obtained by the first User from one or more second Users of the invention, as respectively created, established and maintained by said second User(s) in their respective Profiles, and as exchanged with and Accepted by said first User—said first User's Contacts, as defined here) (collectively, all such User data, including User Account data, hereinafter “User Data”). All User Data, including various Profile information and other relative Account data, is stored within the Web Server portion, on the App portion (installed on and/or otherwise accessible via the User's Mobile Device), on a storage medium or memory portion of the Mobile Device (e.g., a flash memory chip or card, such as an SD or Secure Digital, flash memory chip or card), or a combination thereof. See FIG. 7 showing the login feature the App portion of the invention.

The invention, in a typical embodiment, collects and stores User Data of all Users of the invention in the Database portion stored on or hosted by the Wed Server portion. As further detailed below, the Database portion, and the User Data stored and managed within said Database portion(s), are utilized when, among other things, one User seeks to share Contact Data with one or more other Users. Said User Data is also used by a User to manage his/her Contacts—the Profiles of those other Users that have been exchanged to/with and accepted by said first User.

Upon creation of a User Account, which may also be created by the User via the invention's Website or Website portion, the User may then create various User Profiles, discussed in greater detail below. The Website portion may reside on the Web Server portion—those web servers that comprise and/or host the Web Server portion—or it may reside on other and/or remote Internet web servers. Likewise, various User Data and/or the Database portion(s) of the invention may reside on and/or be hosted on the same Web Server portion that hosts the Website portion of the invention. There are numerous possibilities and the nature, number and location of the web servers used in the invention is not a limitation thereof.

While a User may create his/her User Account after downloading (or otherwise acquiring) the App portion and installing (or otherwise accessing) the App portion on his or her Mobile Device, alternatively, a User may create a User Account before downloading or otherwise acquiring and installing (or otherwise accessing) the App portion on said User's Mobile Device. This may be accomplished, for example, by accessing the Website portion of the invention and creating the User Account therefrom.

After creating a User Account, and prior to using the invention for the exchange of Contact Data, a User first creates at least one User Profile. Each such User Profile comprises and contains specific User defined personal Contact Data consistent with the intended use of the respective Profile created by the User. For example, and as discussed below, a User may create one Profile that would comprise personal Contact Data that the User desires only to share with family members and a separate, second Profile that would comprise other various personal Contact Data that would be more appropriate for sharing with business colleagues or associates. A third such Profile example may comprise only very limited Contact Data that would be appropriate for exchange with a newly acquired social acquaintance and not disclose personal information such as an address or telephone number. A User may create multiple Profiles under an embodiment of the invention. There is no limit to Profile creation. See FIG. 4 showing various Profile categories that may be accessed through the Profile portion of the App portion; see FIG. 5, for adding Contacts through the Contact portion of the App portion—all discussed in greater detail below.

Upon creation of the at least one Profile by the User, the User may open, execute or otherwise access the App portion of the invention for the exchange of Contact Data in accordance with the parameters of information provided by the User with respect to the Profile or Profiles created and desired to be exchanged with a second User of the invention. At or about the time of exchanging Personal Data with one or more second Users, a User may select which Profile, and hence, the corresponding respective Contact Data, to be exchanged with one or more second users (such other Users are herein referred to as “second User”, “third User”, etc. and/or “User 2,” “User3,” “User 4,” etc.)

The GPS portion of the invention comprises the GPR functionality incorporated into the Mobile Device. As discussed below, the App portion of the invention interfaces with and communicates with said GPS portion to implement predefined geographical constraints on the exchange of Contact Data by, between and among two (2) or more Users of the invention. In an embodiment of the invention, and by way of example, when a first User is within close proximity of a second User of the invention, and where the App portion also installed or otherwise available on the second User's Mobile Device, the first and second Users may readily exchange their respective Contact Data with each other, based on the specific Profile selected by each User of the Contact Data to be exchanged. The invention is able to recognize when two such Users are within close proximity to each other by accessing, interfacing with and utilizing the GPS function/feature of each Mobile Device, i.e. the GPS portion. GPS functionality is ubiquitous among current smart/cell phones and other personal/mobile devices and is commonly used in connection with other applications, software, etc. installed on or otherwise accessible via through such devices (e.g., Google Maps, other geo-tracking applications, etc.). Implementation of the GPS portion within the invention and its process(es) is explained in greater detail below.

In another embodiment of the invention, when two (2) or more Users of the invention are not in close proximity to each other, said Users may nonetheless use the invention's unique communications features to exchange Contact Data with each other in similar or identical fashion. For example, two Users communicating by voice to each other through their respective Mobile Devices may want to exchange their business cards, but because of distance, this is not possible. However, through an embodiment, they may use the invention for exchanging Contact Date—digital business cards—as described below.

In yet another embodiment, a User's Contact Date, as established by the User in a respective Profile, may also be shared with one (1) or more other Users of the invention by utilizing the invention's “search” feature or tool (the invention's “Search tool”). The Search tool may be accessed by a User through either the App portion or the Website portion of the invention and is used to search out other registered Users of the invention (those that have created User Accounts). When accessed or executed, the invention's Search tool searches the invention's Database portion of other Registered Users on the Web Serve portion, with said search analysis based on the search criteria or parameters entered by a User. This is common search tool functionality generally known (created) by those skilled in the art and commonly used among users of the Internet (e.g., “Google” search engine, web site search tools, desktop search tools, etc.)

For example, a User may be seeking to exchange Contact Data with Registered Users within a 20 mile radius who specialize in a certain business practice. Or, a User may be seeking to exchange Contact Data with Registered Users of some other defined demographic or parameter employed by the invention at the time that a User creates his/her User Account and Profiles are create and when Users provide various information in accordance therewith. Perhaps a User is trying to exchange family-based Contact Data with all of the members of his or her family—as such, the family name may be searched. A law school graduate User may be seeking other Registered Users within the first User's geographic area that graduated within the User's law school class; the Search tool is capable of searching any parameter, field, etc. of the Database portion of the invention. There are no limits to the types of searches that may be performed by a User of the invention's Search tool.

In accordance with one aspect of the invention, there is provided a method of sharing user data via a global communications network including creating a profile of user data stored on a web server via a software application functioning over the global communications network, accessing the software application with a mobile device, selecting the profile to be shared with another user of the software application, and executing a share function of the software application to share the profile with the another user.

In accordance with a second aspect of the invention, there is provided a method of sharing user data via a global communications network including creating a profile of user data stored on a web server via a software application functioning over the global communications network, the user data comprising at least a name, address, and phone number, accessing the software application with a mobile device, selecting the profile to be shared with another user of the software application, searching for another user of the software application, within a certain proximity, through the use of a Global Positioning Satellite system, identifying the another user based user data of the another user stored on the web server, executing a share function of the software application to share the profile to be shared with the another user.

These and other preferred embodiments of the present invention will be described in more detail below.

### BRIEF DESCRIPTION OF THE DRAWINGS

FIG. 1 depicts a flow chart detailing features of a first embodiment of the present invention;

FIG. 2 depicts a screen shot of an App portion of the invention installed on a device;

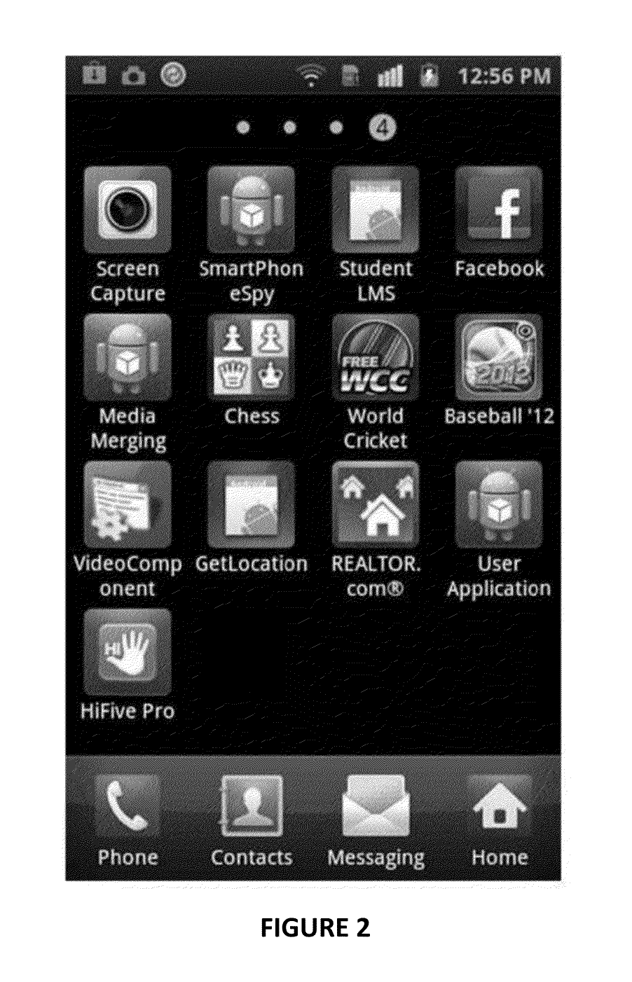

FIG. 3 depicts a screen shot of a sample home page of the Website portion of the invention;

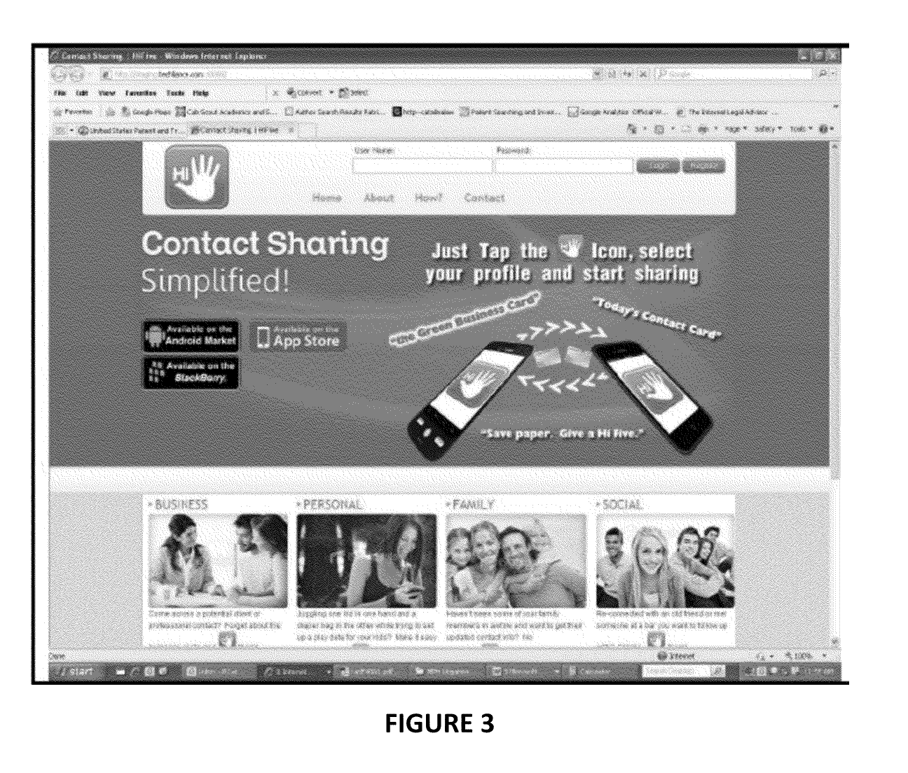

FIG. 4 depicts a screen shot of various Profile categories that may be accessed through the Profile portion of the App portion of the invention;

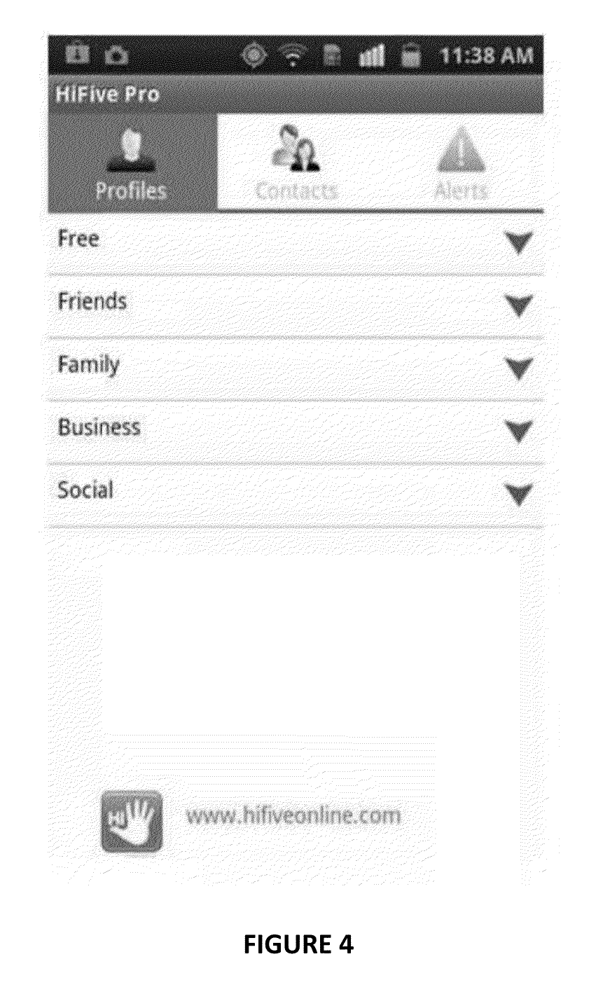

FIG. 5 depicts a screen shot for adding Contacts through the Contact portion of the App portion of the invention;

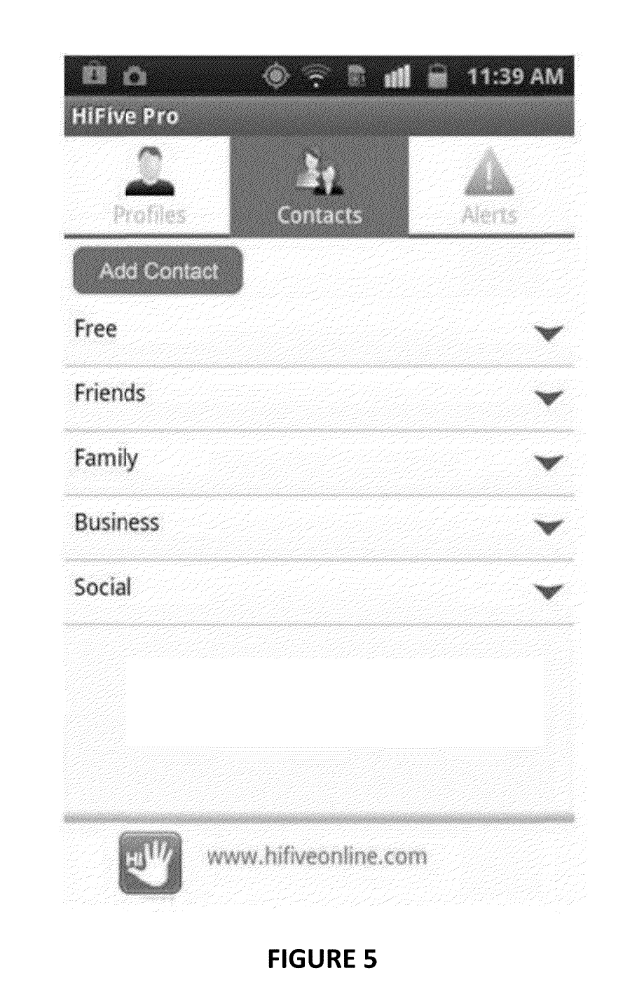

FIG. 6 depicts a screen shot of the Alerts in the App portion of the invention;

FIG. 7 depicts the login feature the App portion of the invention;

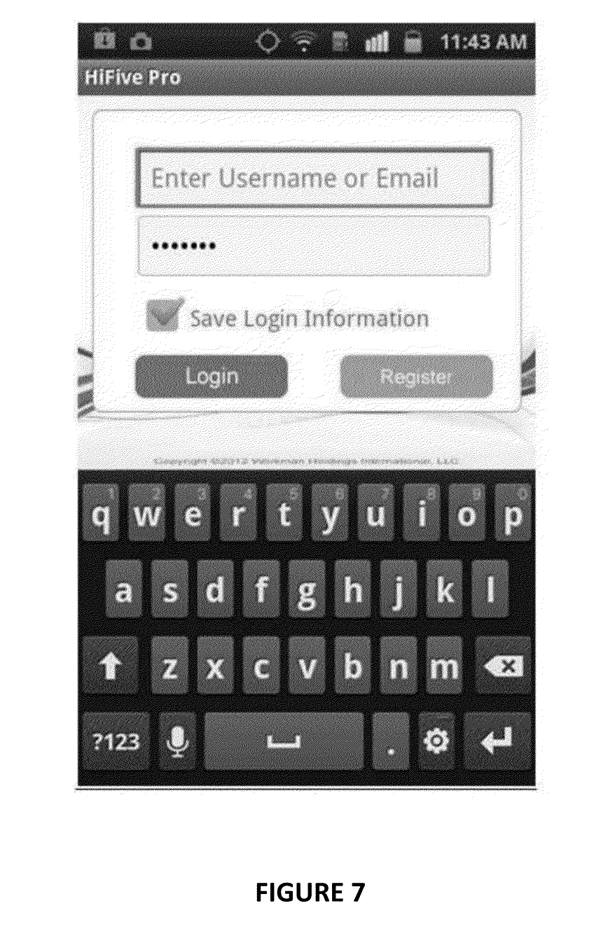

FIG. 8 depicts a screenshot an example of the various data that may be accessed under a particular exemplary Profile field; and

FIG. 9 depicts a screenshot of a map used in an embodiment of the invention.

### DETAILED DESCRIPTION OF THE PREFERRED EMBODIMENTS

A more detailed description of the invention now follows.

Numerous terms in this Non-Provisional Application have been defined herein for convenience. Such definitions are expressly for the convenience of the Application and are not meant to impose any limitation on the various features, elements, portions and embodiments so defined. In addition, defined terms may appear in the Application before their stated definition; in such case, the defined terms are to be given the intended definition, as it is later expressed herein. Defined terms that appear without capitalized letters are still to be rendered with defined meaning, but not limited to as such (i.e., such terms are comprised of, but not limited to, defined meaning).

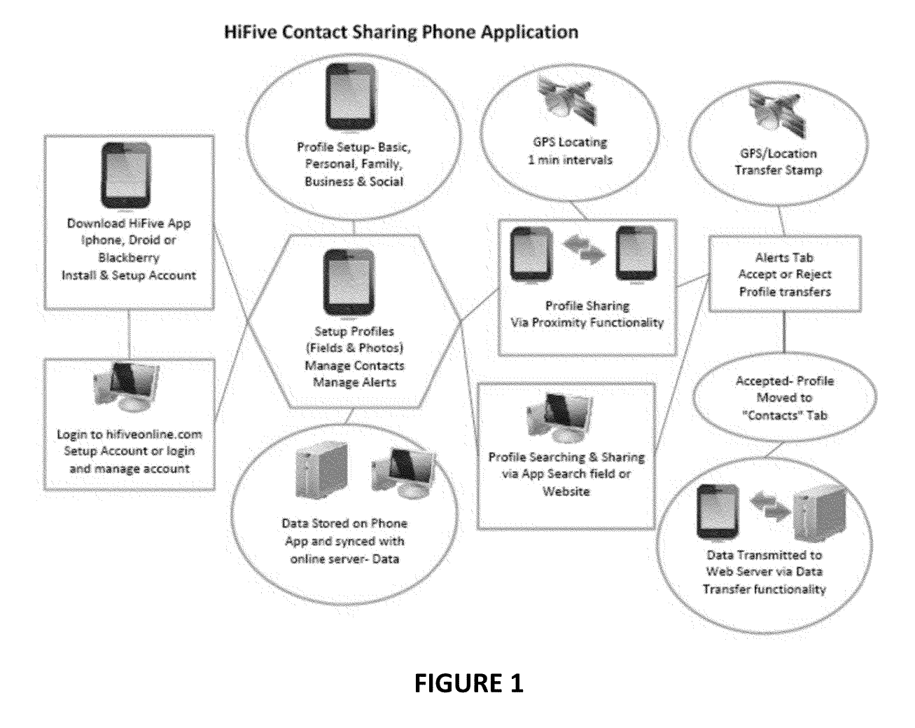

The general process of an embodiment of the present invention is set forth in the flow chart attached hereto as FIG. 1. As previously discussed, in order to execute the invention and share personal Contact Date, a User first creates at least one Profile. Profiles may be created by a User utilizing the App portion of the invention that has been downloaded (or otherwise obtained) and installed (or is otherwise accessible and/or available) on the User's Mobile Device, or by accessing and utilizing the invention's Internet Website portion, User Profiles may be created through either means. Such other means may include integration with social media, for example Facebook, Twitter, LinkedIN. In such case Profiles may be pulled from these third party services and into the User Profile(s). Initial creation of a Profile may also be broadcast through such social media sites.

In an embodiment of the invention, when two or more Users who are in close proximity to each other, such as, for example, at a meeting, party or other social event, desire to exchange their respective Contact Date (as per each participating User's selected, respective Profile) with or among each other, each User may do so by implementing the following initiating steps: 1) accessing the App portion of the invention on his/her Mobile Device, 2) selecting the Profile (and its corresponding Contact Data) to be shared or exchanged with the other Users, and 3) executing the App portion's “share” function (the “Share function”). These are in first steps performed by Users to initiate the exchange process. Upon the Users executing the Share function of the App portion, several additional steps of the invention are implemented and may be executed either serially or in parallel (simultaneously).

An immediate step of one embodiment of the invention involves and invokes the invention's GPS portion. Upon execution by a User of the App portion's Share function, the App portion interfaces with the GPS portion on a User's respective Mobile Device to determine the User's geographic location. The invention ascertains—via the Mobile Device's incorporated GPS technology—the GPS location (the Device's “GPS Coordinate”) of the User participating or seeking to participate in the exchange of the Contact Date. The same process is implemented with other Users participating in said Contact Data exchange.

As such, prior to exchanging any Contact Data from one User to another User, the GPS portion of a participating User's Mobile Device ascertains the GPS location of the Mobile Device (and hence, the respective User) and shares that data with the App portion of the invention.

In an embodiment of the invention, this step is an initial step and performed simultaneously with or immediately after (or about the time) that a User executes the Share function of the App portion. As such, prior to exchanging any Contact Data from one User to another User, the GPS portion of each participating User's Mobile Device ascertains the GPS Coordinates of each User. Upon obtaining the Mobile Device's GPS Coordinates, the GPS portion provides that geographic location data to the App portion of the corresponding Mobile Device. Using the GPS portion of the Mobile Device, the App Portion obtains the Mobile Device's (and hence, the respective User's) precise GPS location/coordinates.

In one embodiment of the invention, upon the App portion obtaining the Mobile Device's GPS Coordinates, the App portion transmits that Mobile Device's GPS Coordinates, and the identity of the Profile selected by the User to be exchanged (as well as its corresponding Contact Data) if stored on the User's Mobile Device via and through the Global Network portion of the invention, to the invention's Database portion located on a Web Server portion of the invention (collectively, all such data transmitted to the Database portion as a result of a User executing the Share feature, the User's “Share Command”).

Alternatively, if a User has not or is not logged into his/her Account at the time that the Share function is executed by the User, then additional data is transmitted with the Share Command—for example, the respective User's identification information, including Account Data, login data, etc., in order to log the User into his/her User Account to continue the exchange process so initiated with the Share function. This data is transmitted over the Global Network portion at or about the same time that the Share Command is transmitted by the User seeking to exchange Contact Data with a second User.

Upon receipt of a User's Share Command by the Database portion, or such other portion of the invention if the Database portion is located and/or hosted by a second, separate Web Server (possibly at a remote location), the invention conducts an analysis of its Database portion to identify other User's of the invention who are currently located within a predetermined distance of the GPS Coordinates as that of the first User according to the GPS Coordinates in that First User's Share Command. For example, upon receipt of a the Share Command of a first User (and the GPS Coordinates of that first User), the invention may be programmed to analyze the Database portion and only identify other Users of the invention that are currently at the same GPS Coordinates as that first User. In such instance, based on current GPS accuracy, the Mobile Devices of each User seeking to exchange Contact Data must therefore be in very close proximate range—within, approximately, two (2) feet of each other. Should the User's respective Mobile Devices be located across the room from each other under such settings, e.g., perhaps at a distance of 6-9 feet, the invention will not identify them to each other, as their respective GPS Coordinates will be different because they are not, per GPS technology, in the same geographical location. As a result, their respective Contact Data will not be exchanged. These distances are subject to modification on the programming level or by a User in certain embodiments and may be increased or decreased as desired or as GPS technology changes. For example, in other embodiments it may be desirable to have the ability to exchange Contact Data with Users many yards or even miles away.

Once the invention identifies Users within the predetermined proximal or geographic range of each other, the invention forwards a User's Contact Data to all such other Users identified by the invention. That is, each participating User's respective Profile Contact Data is issued from the Web Server portion to such other Users within the established GPS geographic location range. By way of example, with three Users all participating in an exchange of Contact Data, and the invention having identified that all three (3) Users are within the prescribed geographic limits as established by and through the invention (which, in an embodiment, may also be determined by each respective User of the invention), User 1's Contact Data (based on the Profile selected to be shared by User 1) is issued and forwarded from the Web Server portion to User 2 and User 3; User 2's Contact Data (based on the Profile selected to be share by User 2) is issued and forwarded from the Web Server portion to User 1 and User 3; and User 3's Contact Date (based on the Profile selected to be shared by User 3) is issued and forwarded from the Web Server portion to User 1 and User 3. Alternatively, Contact Data is issued and forwarded from a location other than the Web Serve portion and transmitted over the Global Network to the intended recipient User. In addition, each respective User may determine which Profile Contact Data to exchange with the other Users. User 1 may want to exchange the Contact Data as established by User 1 in Profile “A,” User 2 may want to exchange the Contact Data as established by User 2 in Profile “B,” and User 3 may want to exchange the Contact Data as established by User 3 in Profile :C,” Variations are limitless.

In an embodiment of the invention, the Contact Data send by a User to a second User through the invention for exchange is received by the second User as a “request” (an “Exchange Request”). A User, in this example, the second User, may “accept” (“Accept” or “Acceptance”) or “reject” (“reject” or “Rejection”) the Contact Data forwarded from a first User and received by that Second User. In this embodiment, the exchange of Contact Data by and between two or more Users is therefore not “automatic” and each recipient User will Accept. Upon Acceptance, a sending User's Contact Data—as per the Profile selected by the sending User—is added to the recipient User's Contacts database, as within the User's App portion and as located in the Database portion on the Web Server portion of the invention. The program may also automatically request that the Acceptor reciprocate the forwarding of a Profile to the sender.

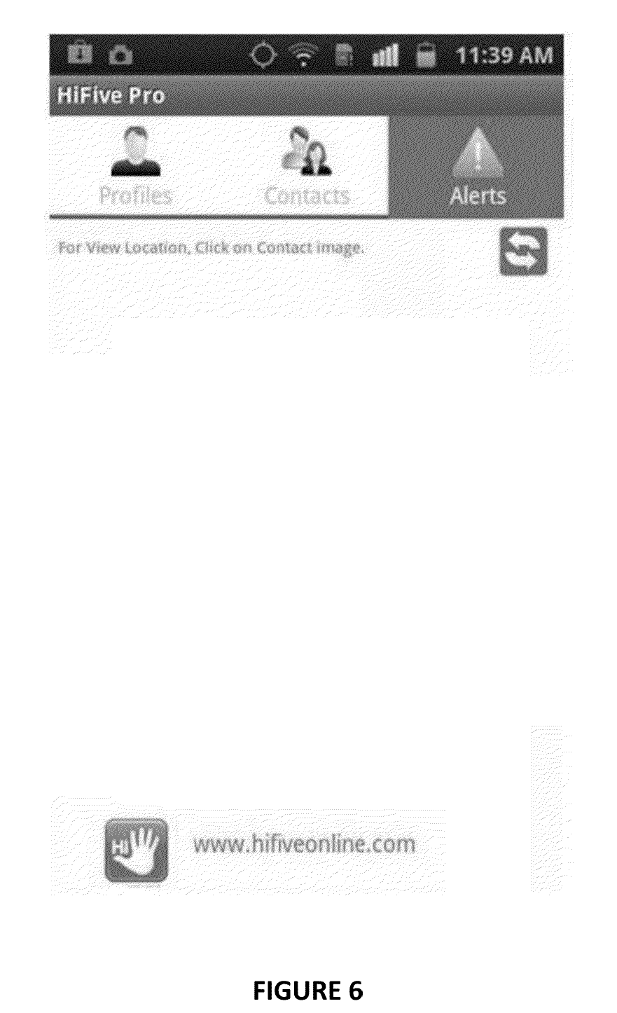

Exchange Requests are received as “alerts (”Alerts“) in the App portion of the invention on the Mobile Device of the recipient User; alternatively, or in combination therewith, such Alerts also may be accessed by a recipient User by accessing his/her User Account through the invention's Website portion. In yet another embodiment, Alerts may also be forwarded via the invention to a recipients User's designated email account(s), text (SMS) number, or such other means for receiving digital communications. See FIG. 6 showing the Alerts in the App portion of the invention.

In an embodiment, a Rejection of an Exchange Request by a receiving User simply results in the Contact Data of the sending User be rejected and that Request, and all data associated therewith, is deleted from the recipient User's Mobile Device and/or the User's User Account. In such case, the User that initiated the Exchange Request by executing the Share function (typically performed at or about the same time by two (2) or more Users seeking to exchange Contact Data with each other) does not know whether his/her Contact Data has been accepted or rejected by the intended recipient User.

If an Exchange Request received by a recipient second User is Accepted, the Profile of the first User that initiated the Exchange Request (as determined by the first User when executing the Share function), is added to a “contacts” (“Contacts”) feature or portion of the recipient User's App portion. Profiles of those other Users that have been Accepted by a User into his/her Contacts may be managed, organized and deleted by said User by accessing the Contacts feature of the App portion. Alternatively, a User may manage his/her Accepted Contacts by accessing the Contacts feature through the Website portion of the invention by logging onto said User's Account. In addition, Contact Data (as per the User Profile exchanged) in a User's Contacts may not only be viewed and managed, but utilized for immediate communications. For example, the Mobile Device telephone number of a particular Contact (User 1) may be “dialed” or “called” by User 2 by User 2 accessing User 1's Profile through the Contacts feature on User 2′s Mobile Device and executing the “call” function of the invention associated with all such telephone numbers. Or, a text or SMS message may be sent by User 2 to User 1 in similar fashion. Or, an email may be sent from User 2 to User 1 by executing the “email” function of the invention associated with all such emails listed in the Profile (and hence, Contact Data) created by User 2 and forwarded to and exchanged with User 1 via a Data Exchange. All of these features and functions, among others may be accomplished and executed by User 2 through his/her Mobile Device (by accessing the App portion of the invention) or by User 2 accessing his/her User Account through the Website portion of the invention. All Contacts of, Alerts received by, and Profiles created by a User may be accessed, viewed and managed through both the App portion and through the Website portion of the invention.

Various aspects, features and elements of the various non-limiting embodiments of the invention are further disclosed and discussed in greater detail as follows.

### Graphic User Interface of the App Portion

After downloading the App portion from the invention's Web Site portion and installing on a User's Mobile Device and configuring it according to the User's preferences, the App portion of the invention is ready for use by the User and ready to integrate and communicate with other features and elements of the invention.

After installation and configuration on a User's Mobile Device, the User may access and use the App portion by “opening” the program in accordance with the established protocols of the Mobile Device's operating system and/or in accordance with such other means and methods for accessing installed mobile device application as commonly known. Upon accessing the App portion on a User's Mobile Device, in an embodiment, the “opening screen” user interface (GUI) of the App portion presents the User with the ability to login to the User's User Account using secure account access protocols and means, such as, for example, by User name and password, as established by the User when creating his/her User Account (all User Account information is stored securely on the Web Server portion, which may also host the Website portion or on other web servers possibly at remote locations). Alternatively, upon accessing the App portion installed on a User's Mobile Device, the User is presented with an opportunity to “register” a new User name and password; again, said User's User Account data being stored securely on the Web Server portion, which may also host the Website portion or on other web servers possibly at remote locations. Such User Account data may also be stored or saved on a User's respective Mobile Device, thereby allowing easy login and access to the invention's features and functionality.

Upon a User logging into his/her account, the App portion of the invention is connected with the Web Server portion of the invention via the Global Network portion and its wireless technologies and protocols. In an embodiment of the invention, upon such connection by and between the App portion and the Web Server portion, the User Data as stored on or within the App portion of the invention on the Web Server portion of the invention. As User Data may be stored on or in both a User's Mobile Device and on the Web Server portion, and changes may be made to said User Data through either the App portion or through the Website portion of the invention, it is important that regardless of how or from where the invention is accessed by a User, the most up-to-date User Data is made available for use by the User. As such, immediately upon logging by a User into his/her User Account, various data synchronization mean(s) are implemented so that the most recent version of the User Data is made available to the User. Such newer User Data may include additional Contacts, updated Profiles, recently received Alerts, or other pertinent User Data.

Therefore, in said embodiment, upon execution (assessing or opening) of the App portion, an immediate data communication connection is made by and between the User's Mobile Device and the Web Server portion. In the event that additional features of the invention are utilized, such as the Share function, a data connection has already been established so as to allow for the quick, easy transmission of any data between the Mobile Device and the Web Server portion.

All User account data and credentials are saved and stored remotely on the Web Server portion, as assigned to the User's User Account. Once a User registers with the invention, thereby creating a User Account, using the “registration” feature of the App portion—readily available upon opening or accessing the App portion and transmitting data through the corresponding Mobile Device—or by using the invention's Website portion, all User credentials are saved and stored. Both login and registration functionality use of the Mobile Device's data transfer capability to connect to and communicate through the Global Network portion with the Web Server portion, to login into and/or establish a User Account for the User and/or to verify the correct login information for the User.

In an embodiment, upon opening the App portion by a User and logging onto his/her User Account, the User is typically presented within the interactive user interface of the opening App portion with one or more feature options, typically appearing or expressed as hyperlinked “tabs” for selection by the User. In such embodiment, the User is presented with three (3) tabs for selection by the User for the following features: “Profiles,” “Contacts” and “Alerts.” In addition, in an embodiment, the App portion may present the User, through a hyperlinked tab or other ready means, quick and easy to the Website portion through the User's Mobile Device, which may open in the Device's mobile web browser or other similar program for viewing and accessing.

The following are the primary features of the App portion of the invention, all of which may also be accessed through the invention's Web Site portion as well:

### “Profiles” Feature

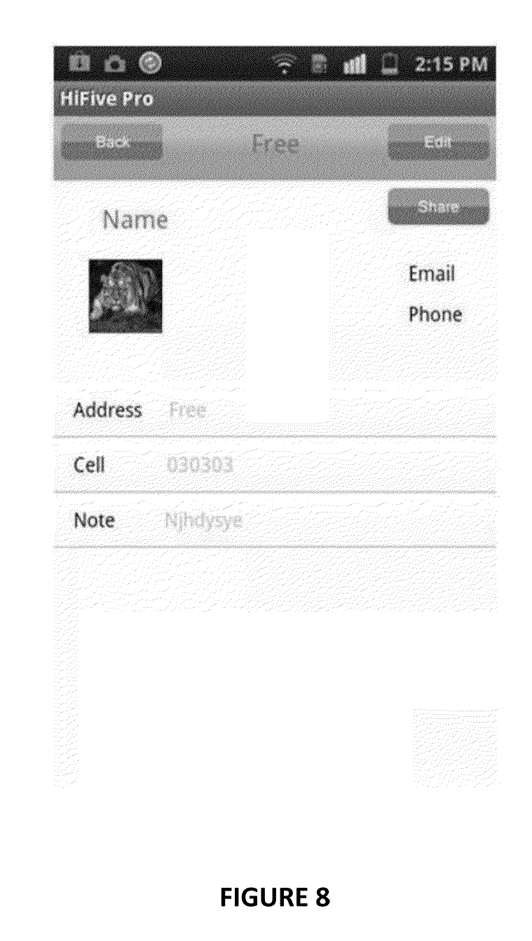

In an embodiment, the App portion's Profiles feature may be accessed by and through the “Profiles Tab.” The Profiles tab is clicked and Users may establish one (1) or more “Profiles” of a specific User contact information to be exchanged, depending on which “Profile” selected by the User at the time of the exchange. The invention requires at least one Profile to be established by the User and in such event would comprise the User's default Profile Contact Data exchange setting. FIG. 8 depicts a screenshot an example of the various data that may be accessed under a particular exemplary Profile field.

A User may establish or create numerous Profiles. In an embodiment, a User is presented with the ability to establish or create anywhere between one (1) and five (5) separate Profiles. In other embodiments greater number of Profiles may be created. Once created by a User, a Profile may always be managed—edited or even deleted. New Profile(s) may be created. A Profile can be viewed, setup or even “shared.” In addition, an image of the User—such as a digital photograph file such as jpeg or jpg—may be associated with a particular User Profile. Or, a User may assign any other digital image(s) to a Profile, based on the User's preference.

If a User would like to “Share” a specific Profile with another User of the invention within a close proximity to said first User, or with any other Registered User appearing or located within the Database portion of the invention, the User must access and execute the Share function via a “Share” button, tab or link appearing in the interactive user interface of the App portion that implements the Share function.

### “Contacts” Feature

“Contacts” is that feature of the App portion (which may also be accessed via the Web Site portion) of a User's Account Data wherein prior Exchange Requests from other second Users have been Accepted by the first User and are stored for easy access through the App portion or through the Website portion. Once Accepted, the Profile of the User forwarding the Exchange Request is added to the recipient User's “Contacts” database. A User may review and manage all of the User's Contacts—and the Profiles associated with each Contact—that the User has Accepted.

In an embodiment, a User's Contacts may be organized by category. For example, a User's Contacts may be organized by categories such as (but not limited to) “Free” (based on a simplified embodiment of the invention that is available for free download), “Friends,” “Family,” “Business” or “Social” categories, with respective Profiles under each such category. The names of these categories may be modified by the User in some embodiments of the invention. Additional categories may also be created or existing categories may be deleted. Contacts may be listed with a photo of the User Contact (if available/sent) by the sending User). Various Contact information is also presented under each Contact, depending the Profile and Contact category.

In an embodiment, then a User access his/her Contacts within the App portion on the User's Mobile Device, and the User selects a listed Contact and its associated Profile, the selected Contact Profile will open and present itself as a fill screen display on the Mobile Device, with all incorporated Profile fields (Contact Data) available for review and access by the User.

In addition, in an embodiment, a hyperlinked tab, link or button is also presented within the opened App portion, for example, within any opened Contact Profile or listing of the User's Contacts, that, when accessed, executed or “clicked: will open a “search” page and present the User with the ability to search the invention's Database portion for other, specific Registered Users. Alternatively, an embodiment may incorporate an “Around Me” search function, which interfaces with the invention's GPS portion to locate or Registered Users within a defined geographical proximity (e.g., within 100 feet, etc.), in which the first User may want to Share his/her Contact Data, as within a selected Profile to be shared via an Exchange Request (Share Command).

### “Alerts” Feature

Opening or accessing the “Alerts” feature will display all requests for the sharing or exchange of Profiles that have been forwarded to a User by other second Users through the invention's Share function.

The Alerts feature may be accessed through a hyperlinked tab, link or button that is also presented within the opened App portion, and when accessed, executed or “clicked,” the App portion opens a page or otherwise makes available for view by the User all of the Exchange Requests received by that User, along with each such Profile of the forwarding User seeking to exchange Contact Data with the first User. As noted, any User may Reject or Accept a Request as to another User's Contact Data. Upon Rejection, the Profile send to the recipient User will not be added to the User's User Account, the User's “Contacts” database or the User's Contact listing, as set forth in the opened App portion (all such areas are integrated and synchronized). Upon “Accepting” the Profile sent to the recipient User, the Profile and its attendant Contact Data will be to the User's User Account, the User's “Contacts” database and/or the User's Contact listing, as set forth in the opened App portion (all such areas are integrated and synchronized). The Accepted Contact and its Profile of the second User will then appear in the first User's Contacts feature of the App portion.

### Proximity (GPS) Functionality

In an embodiment, User Profiles can easily be shared with other Users of the invention who are located within a 1-2 foot proximity of each other, based on a pre-determined GPS range identification settings, as the Mobile Device uses GPS positioning to locate other Users of the invention who are within that geographical range. This allows Users who are located physically next to each other to immediately connect and share their respective Profile and Contact Data by simply clicking or executing the hyperlinked “Share” button, tan, icon, etc. (however it may be expressed within the App portion's interactive user interface). Under search results conducted by the “Around Me” function, or by using search terms entered into the invention's Search tool, a User may send or forward his/her selected Profile to each such search result by using the same or similar functionality.

In addition, the App portion may broadcast and store the GPS Coordinates of a first User onto the Database portion located on the Web Server portion and match and/or compare those GPS Coordinates to other Users entered in or otherwise within the Database portion to identify such other second Users within a predetermined geographical proximity or location as that of the first User. When the locations of one or more second Users are identified as being within a close or “matched” proximity to the first User—based on the GPS Coordinates of each such User—the Database portion and/or Web Server portion will allow for those Users to exchange their respective Contact Data (based on Profile selection by each User) to each other by executing the Share function. GPS functionality must be enabled on a User's Mobile Device and while the App portion is open/accessed and available for utilization. In an embodiment, when the App portion is opened or otherwise accessed, that feature of the invention automatically interfaces with the Mobile Device's GPS portion and requests of and obtains from the GPS portion the GPS Coordinates of the Mobile Device. The App portion holds that information or data, and then, via the Global Network portion, employing wireless communications technologies, “pings” the Web Server portion once every minute (by default setting, which may be changed) to update the Database portion thereon of the location of the User, as per the User's Mobile Device. As such, a User's location is posted to the Database portion on the Web Server portion approximately every minute and the User's location may be further tracked over a period of time. User locations are posted on the Web Server approximately every minute.

### Data Transmission

In one embodiment, the App portion connects to and communicates directly with, via the Global Network portion, the Web Server portion on the initial signup/login screen (when the App portion is opened or accessed by a User) on a User's Mobile Device. The App portion uses the Mobile Device's data transfer functionality to communicate with the Web Server portion, thereby allowing for seamless new User registration or existing User login. When a new Profile is created or edited by a User or when a User Accepts a new Contact from a second User, the associated data therewith is stored on the Mobile Device and said Data is also transmitted via the Global Network portion to the Web Server portion and/or Website portion, or a combination thereof, for synchronization and online storage.

### Data Storage and Server(s)

The invention does not limit the amount of User Data stored within the App portion installed on the User's Mobile Device (or the Mobile Device itself, with its various storage media, including flash media) or on invention's Web Server portion(s) that store User Data. The only limitation to the amount of User Data that may be stored on a particular Mobile Device are the limitations of the Device itself (its physical data storage capacity).

In one embodiment, User Data is stored on both: the User's Mobile Device and on the invention's Web server portion. If a User loses his or her Mobile Device, or it ceases to function, the User may readily access his or her User Data and reinstall that data on a new Mobile Device by logging into said User's Account.

### Location/GPS Stamping

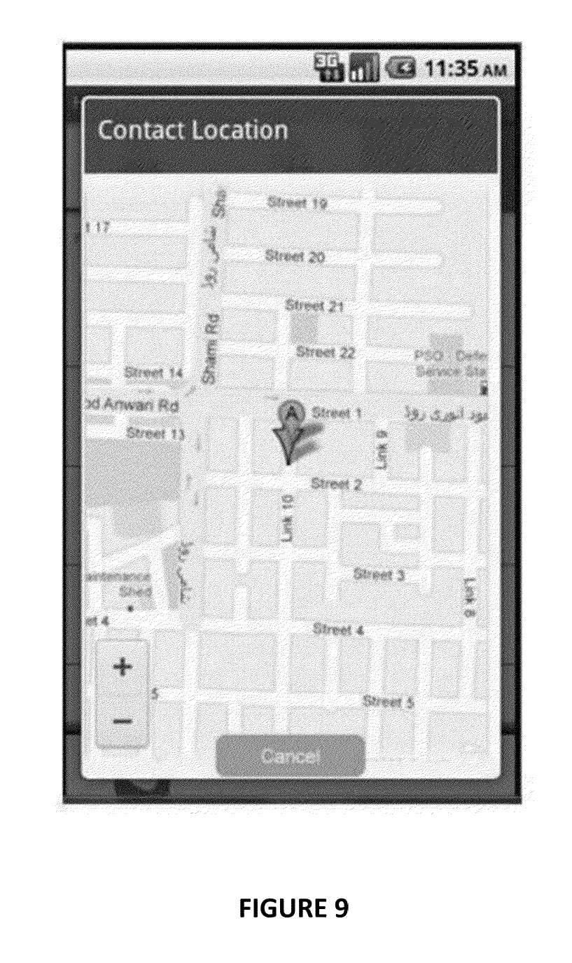

Since the invention uses and comprises, in an embodiment, a GPS portion, the GPS functionality of the Mobile Device is thus active, enabled and is interfaced with the App portion of the invention when the App portion is opened or accessed. In addition, when a Profile is shared, transferred or exchanged by and between two (2) or more Mobile Devices, all such Users participating in the exchange of Contact Data have the ability to post a GPS transactional “stamp.” This feature or function may be posted to an integrated or third party map “add-on” feature, thereby allowing Users to see, from a map (geographic location graphic) where the exchange transaction took place. See FIG. 9 for a screenshot of such a map.

### Exemplary Profile Fields and Setup

All Users can add specific data to each pre-defined field of information within a Profile category. An embodiment of the invention, for example, comprises five (5) Profile categories: Free, Friends, Family, Business and Social. Once the Profiles are setup by a User, the data of each such Profile is saved within the App portion and is also save or stored on the Web Server portion (in the Database portion residing thereon), as previously discussed. Additional Profiles may also be added by the User.

A User has the ability to send an individual Profile to one or more second User(s) or a User may send multiple, selected Profiles to one or more second User(s) for exchange and saving thereof by said second User(s). This option may be implemented, for example, by presenting the sending User with the ability to select, using radio check boxes or other such selection means generally known and available, at the time of the User seeks to share or exchange his/her Profile by executing the Share function.

Exemplary Profile “fields” in an embodiment of the invention include the following (by way of example only):

### “Free” Profile Embodiment:

1) Name

2) Email, and

3) Phone number

### “Friends” Profile Embodiment

1) Name

2) Address

3) Email

4) Profile Photo

5) Home Phone

6) Cell Phone

7) Facebook Page

8) Twitter Page

9) Wife/Husbands Name

10) Kids Name(s), and

11) Notes

### “Family” Profile Embodiment

1) Name

2) Address

3) Email

4)Profile Photo

5) Cell Phone

6) Home Phone

7) Birthday

8) Wife/Husband Name

9) Wife/Husband Birthday

10) Wife/Husband Anniversary

11) Children Name(s)

12) Children Birthday(s)

13) Medical Notes, and

14) Note.

### “Business” Profile Embodiment

1) Name

2) Address

3) Email

4) Website

5) Profile Photo

6) Business Name

7) Title

8) Cell Phone

9) Office Phone

10) FAX

11) Assistant's Name, and

12) Notes

### “Social” Profile Embodiment

1) Name

2) Address

3) Cell Phone (SMS)

7) Facebook Page

8) Twitter Page

### Contacts Tab/Collection

The App portion of the invention collects User Profiles and Contact Data that have been Accepted by the User and stores them on the User's Mobile Device. In an embodiment, a User may access said stored Contacts—and their respective Profiles that they have exchanged with the first User—by accessing (clicking) the “Contacts” tab or link in the interactive user interface of the opened App portion. In addition to storing Accepted Profiles and each such Profile's respective Contact Data on the Mobile Device (which may be accessed via the “Contacts” tab), once a User logins onto the Web Server portion (which may or may not be hosted by the same Internet web servers comprising the Web Server portion), said Contacts may be accessed and managed therefrom. Contacts are organized under various pre-established categories, or by default, based on the type of Profile under which the Contact was created by the sending User.

In an embodiment, a User may view details and specific fields for each of the User's Contact (either through the interactive user interface of the App portion or the graphic user interface of the Website portion) by clicking on the Contact photo and name under the Contacts tab. Upon viewing a respective Contact's detailed Contact Data, a User may perform any of the following functions (in addition to others not listed below): A User may send an email to the any Contact listed under said User's “Contacts list” by clicking on the email address listed therewith and Contact; A User may make a telephone call by clicking on the telephone number listed therewith said Contact; A User may “re-share” any of the Profiles that comprise his/her Accepted Contacts (discussed below).

A User may share the Profiles of Contacts Accepted by that User (a “Shared Profile”). However, in order for a Profile to be shared by with another second User, the Shared Profile will be presented to said second User via an Alert, discussed previously, and that second User may either Accept or Reject the Profile forwarded by the first User and sought to be shared by that first User. By way of example, John has previously Accepted the Profile and Contact Data of James. John would like to shares James' Profile and Contact Data with Mary. Using the invention's “shared profile” feature, John forwards James' Profile and Contact Data to Mary. The forwarded Profile and Contact Data of James appears as an Alert in the App portion on Mary's Mobile Device. Alternatively, as with all Alerts, the James Alert may also be viewed and accessed by Mary by logging onto the Website portion of the invention and accessing her User Account. Mary may either Accept or Reject the forwarded James Alert; Acceptance and Rejection results are the same as previously disclosed.

In addition, in an embodiment, a User may search other Users by other identifying indicia, such as, for example, first, last and Profile name, using either the App portion of the Website portion. A User may send an invitation to the other Users with his/her Profiles and a message note. When User invites other second Users as such, the first User's current location (determined by the GPS portion) will be sent with invitation. In an embodiment, when a second User Accepts or Rejects the invitation received from the first User, said second User may have ability to view GPS time Stamp on Google map by clicking on image.

### Alerts Feature

In yet another embodiment, when a User updates his/her Profile from the Website portion, a notification may be generated from the Web Server portion and forward to said User's Mobile Device alerting and notifying the App portion on the Mobile Device of said update(s). In addition, a hyperlinked synchronization button, tab, icon, etc. may be presented to the User when said User receives that update notification, thereby allowing for immediate, easy updating and synchronization of the User's User Data on the Mobile Device. Updated or new User Profiles may be synchronized with the Web Server portion, thereby providing a User with the most up-to-date User Data in that User's Mobile Device.

In a further embodiment, a User may forward a Profile to a non-User of the invention through e-mail, text messaging, or other means. Inclusive of the Profile may be an invitation to become a User of the invention.

In an additional embodiment, upon Acceptance of a Profile of another User, a User may attach an additional “note” to the Profile where such “note” is only viewable by the drafting User. Such an action is akin to writing the note on the back of a physical business card. In another embodiment, such a “note” may be attached to a profile by a User to be viewed by other Users upon Acceptance of their Profile.

In a further embodiment, the invention may include the ability for a User to retract a Profile previously forwarded to another User.

The images in the drawings are simplified for illustrative purposes and are not depicted to scale. To facilitate understanding, identical reference numerals are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore numerous modifications may be made to the illustrative embodiments and other arrangements may be devised without departing from the spirit and scope of the present invention. It has been contemplated that features or steps of one embodiment may be incorporated in other embodiments of the invention without further recitation.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A method of sharing user data via a global communications network, said method comprising:
creating a profile of user data stored on a web server via a software application functioning over the global communications network;
accessing the software application with a mobile device;
selecting the profile to be shared with another user of the software application;
executing a share function of the software application to share the profile with the another user.

2. A method of sharing user data via a global communications network, said method comprising:
creating a profile of user data stored on a web server via a software application functioning over the global communications network, the user data comprising at least a name, address, and phone number;
accessing the software application with a mobile device;
selecting the profile to be shared with another user of the software application;
searching for another user of the software application, within a certain proximity, through the use of a Global Positioning Satellite system;
identifying the another user based user data of the another user stored on the web server;
executing a share function of the software application to share the profile to be shared with the another user.
